(19) United States
(12) Patent Application Publication
(10) Pub. No.: US 2017/0326465 A1
(43) Pub. Date: Nov. 16, 2017

(54) Clear Intact Bottle with a Figure or Effigy within, which is Visibly Larger than the Bottle's Opening

(71) Applicants: Robert P. Mascarelli, Spring Hill, FL (US); Gloria B. Mascarelli, Spring Hill, FL (US)

(72) Inventors: Robert P. Mascarelli, Spring Hill, FL (US); Gloria B. Mascarelli, Spring Hill, FL (US)

(21) Appl. No.: 15/150,746

(22) Filed: May 10, 2016

(51) Int. Cl. A63H 3/50; F21S 8/00; A63H 3/04

(52) U.S. Cl. CPC A63H 3/50; A63H 3/04; F21S 8/035

(57) ABSTRACT

A glass or plastic intact bottle with a figure or object inside it, which is larger than the bottle's opening is disclosed. The insertion method is uncomplicated and it preserves the integrity of the bottle without creating a seam. It is accomplished by our means of insertion, using a vinyl, PVC, rubber, latex or other polymer “squeezable” figure, compressed into a compact form. The figure is twisted, or rolled through a small bottle neck opening with or without the use of a lubricant or a funnel. When released from compression the figure assumes its original size within the bottle. Thus a simple solution to the placement of a large item in small space is achieved, with no visible clue as to how it got in there. The invention has applications for use as a curiosity or novelty, for production as a creative children's arts and crafts set. or created as a night light with or without a musical cap.

### BACKGROUND OF THE INVENTION

The present invention refers to a novelty product, having multiple applications, that uses a glass or plastic bottle, and a hollow molded polymer figure. Recent developments in the field of soft polymer manufacture has made it possible to create materials that can be rotation molded, slush molded or otherwise molded into thin skinned hollow figures that are capable of being compacted into a smaller size and likewise capable of expanding to its original size when released from its compressed form. By inserting such a figure into a clear plastic or glass bottle or container which has an opening or neck that is considerably smaller than the object which is inserted in it, a novelty object is created. The observer of such a novelty object is left wondering how the large figure could have gotten into such a small necked bottle.

Each project for a bottle novelty will be organized separately according to the size of the production and the variation in size and shape of each bottled figure. The figures or objects can vary greatly in size and subject matter. Appropriate bottle sizes are to be matched to each figure size. Each bottle will be made of clear glass or clear plastic with a small mouth and neck opening at one end. Molded figures of a thin pliable polymer materials such as vinyl or PVC will be hollow molded for use as insertions into the bottle through the narrow neck opening. After the figures are colored in a realistic way that may include silvering or coloring with gilt, they are then rolled and squeezed through the top of each bottle either by hand or mechanical device. The figure then expands to its original form, significantly filling the interior space of the bottle, thereby making it impossible to remove after insertion.

Heretofore, there have been attempts to create the illusion of a large object in small necked bottles. The sailing ship in a bottle is a prime example, of an object that is folded on a small plank and inserted through the neck of a bottle. After insertion the sails are hoisted from outside the bottle by means of a string (U.S. Pat. No. 2,730,827 A to Patterson). using were expanded by the use of heat and gases to attain a size larger than the bottles opening (U.S. Pat. No. 2,498,074 A to Feldman, Feb. 21, 1950). Other novelty bottles cut off the bottle's bottom and insert a large object in the cavity which is then covered by an opaque detachable bottom that conceals the cut (U.S. Ser. No. 08/357,391 to Toffler and Hough, Apr. 2, 1996). Another approach uses a folded figure with a spring loaded mechanism in the figure which pops open after insertion (U.S. Pat. No. 6,575,807 B2 to Spector, Apr. 27, 1999).

In addition there have been other “Impossible” bottles created by other means, all of which require extensive preparation or construction time. Examples of this are Rubick's cubes that have been dis-assembled and then re-assembled by hand inside a bottle using glue to attach the pieces together. Tennis balls have been collapsed and inserted into small openings in bottles and then blown up from outside the bottle to assume their original shape, as have pingpong balls and various other items. Construction of “whimsies” that entail extensive design, preparation, and construction by hand using glue as an adhesive to attach the pieces within the bottle have also been created.

It is apparent from what has been mentioned above that the prior art is complicated and time consuming, and that it requires adult skill to accomplish the illusion of a large object in a small necked bottle, whereas our invention accomplishes the same goal with minimal skills of folding or squeezing the figure or object to place it into a bottle, a skill which can be performed by a child.

### BRIEF SUMMARY OF INVENTION

By our means of using a soft flexible vinyl, PVC, rubber. latex or other polymer “squeezable” figures, that can be rolled or squeezed through the narrow opening at the top of a clear plastic or glass bottle or container, we provide a simple solution to the illusion of a large item in a small space with no visible clue as to how it got in there. Our invention makes it seem that the figure appeared magically within the bottle. The claimed invention differs from what currently exists. Other attempts to place objects in bottles use complicated methods to insert the figures into the bottles that are time consuming (actually building a ship in a bottle by means of strings and glue).

Our insertion method is uncomplicated and it preserves the integrity of the bottle without creating a cut or a seam. Rather than the complicated and/or time consuming techniques referred to in the citations, our insertion technique is so simple it can be done by a child. Thus the invention lends itself to an application as a children's arts and crafts set, or as a night light with the addition of a lighting source as a cap. A musical bottle cap could also be added.

### BRIEF DESCRIPTION OF THE DRAWINGS

FIG. 1 depicts a clear vertical plastic or glass bottle or clear container of any size or shape with a visibly small opening as the entrance to the container (as in soda bottle, whisky bottle, etc.) FIG. 2 depicts a clear horizontal plastic or glass bottle or clear container of any size or shape with a visibly small opening as the entrance to the container (as in soda bottle, whisky bottle, etc.) FIG. 3 Depicts optional positioning posts in bottles.

FIG. 4 Depicts a stabilizing stand for horizontal bottles.

FIG. 5 Depicts an optional funnel used for guiding the figure into the bottle.

FIG. 6 Depicts a type of bottle cap with an optional label section on it.

FIG. 7 Depicts an optional vertical positioning tool used for positioning the figure on the positioning post. of a vertical bottle.

FIG. 8. Depicts a optional horizontal positioning tool used for positioning the figure on the positioning posts of a horizontal bottle.

FIG. 9 Depicts a hollow thin walled flexible polymer molded figure.

FIG. 10 Depicts a paint set figure as it is being hand painted.

FIG. 11 Depicts a figure in the process of being painted

FIG. 12 Depicts the painted figure being squeezed through the opening of a narrow necked bottle.

FIG. 13 Depicts the painted figure fully inserted and expanded within the bottle shown with an LED button and a musical button. on the cap.

FIG. 14 Depicts some possible bottle caps, showing two types of figural caps.

FIG. 15 shows a figure in a bottle with a source of illumination that can be incorporated into the bottle cap thereby allowing its use as a night light.

FIG. 16 shows a figure that has been inserted into a bottle which is held in place by the circumference of its base without the use of a positioning post.

### DETAILED DESCRIPTION OF THE INVENTION

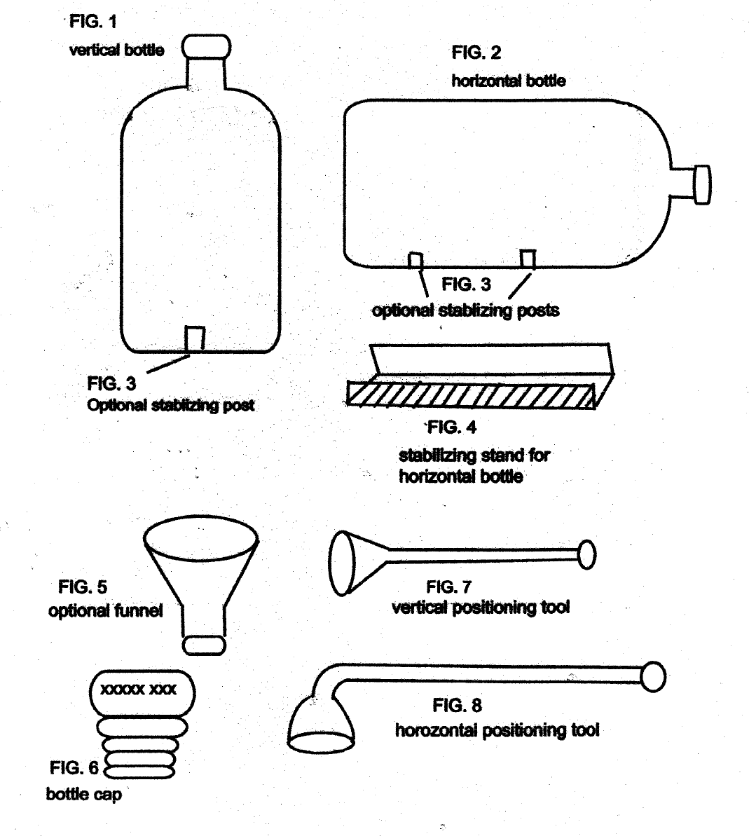

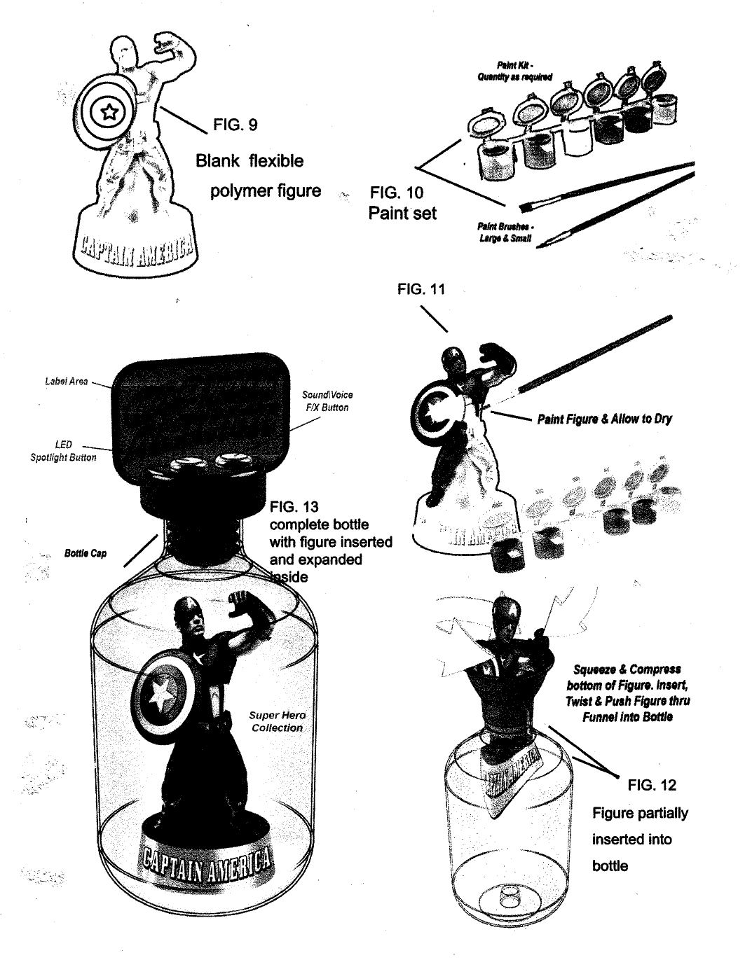

How can a figure appear to have been magically inserted into an intact plastic or glass bottle? The invention claimed here solves this problem. We are using a clear plastic or glass bottle, positioned vertically or horizontally (FIGS. 1 and 2) along with a vinyl, PVC, rubber, latex, polymer or other malleable substance material made into the form of a figure which can be rolled, folded or compressed to diminish the size of the figure to a smaller dimension. Such a figure can be hollow molded with fine detail in a rotational molding machine or other machine capable of producing soft thin walled hollow molds (FIG. 9). The figure can then be painted (FIG. 10 and FIG. 11) and then compressed in size to accommodate the small opening of a clear bottle. The figure to be inserted into the bottle must be flexible enough to squeeze through the opening of the bottle by means of pushing, rolling, squeezing, folding or similar motions used to diminish the size of the featured figure or object. It is then to be pushed in by hand or mechanical device or any other practical means of insertion in its reduced size (FIG. 11).

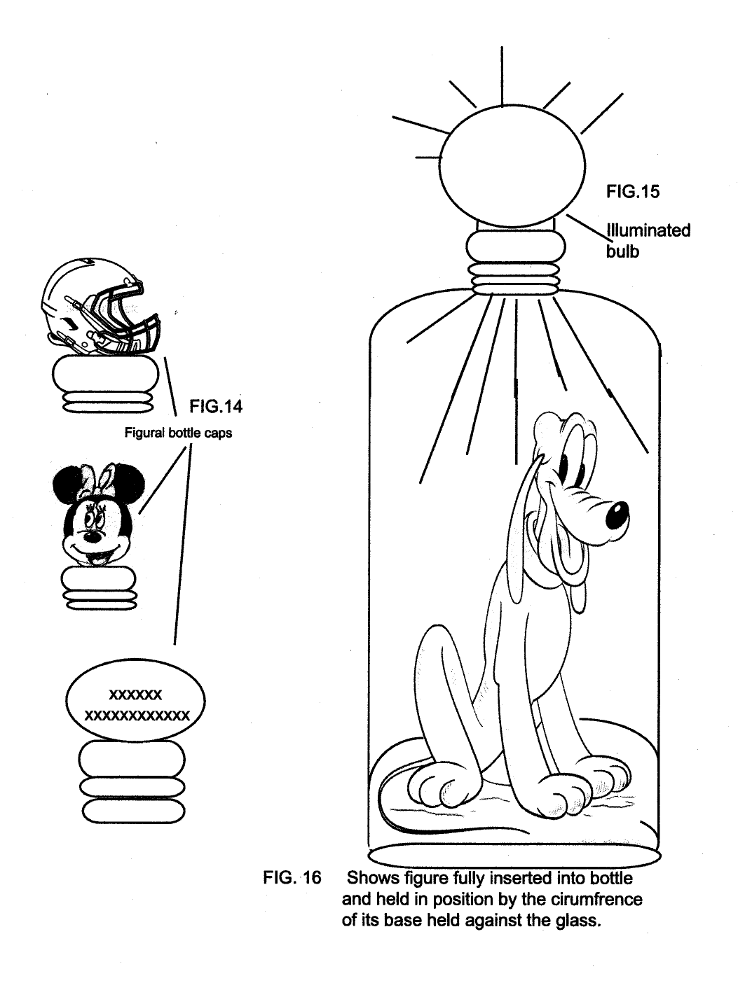

It is crucial that the figure's material composition provides the ability for it to assume a distorted shape in order to be inserted into the neck of the bottle, while maintaining the figure's structural integrity, and that it has the ability to expand upon release into its original shape within the bottle after being squeezed into it (FIGS. 12 and 14). Such insertion may be assisted by the use of a funnel (FIG. 5). The clear bottle or plastic container may be molded with an insertion post or posts used to stabilize the figure in the bottle (FIG. 3), and If posts are used to secure the position, there may be positioning tools provided to set the figures upon the posts (FIGS. 7 and 8). A horizontal bottle can be stabilized with a stand to hold it in position (FIG. 4). If the bottle is molded without posts, the figure may be held in place within the bottle by the girth of the figure held against the glass walls of the glass or plastic bottle, or otherwise being secured by the diameter of the base fitted snugly against the walls of the base of the bottle (FIG. 16). When inserted into the clear plastic or glass container, the expanded figure will then confound the viewer as to how it got into the bottle.

Post insertion, the figure or object becomes the focal point, appearing to have been magically placed within the cavity of the bottle, appearing larger than the opening through which it was passed. Many types of subjects can be used for the figures such as: animals or fish, Marvel super heroes, sports figurines, Disney cartoon character, famous people, transportation items, city profiles, sci-fi figures, famous architectural structures, mythological beasts, human anatomically related objects or organs, and other figures or objects. (FIGS. 13, and 16).

We have invented a novelty bottle item which can be used as a toy, a promotional device for advertising, a souvenir, a decorative display, a night light (FIG. 15 and for any other creative purpose. It can be utilized in any size or shape clear glass or plastic container with an opening smaller than the object that is positioned within it. As such, the novelty bottle can become the key element in the creation of a Children's Arts and Crafts Set, wherein a mold or molds are provided along with suitable bottles, preferably enclosed along with a non-toxic acrylic paint and brush set (FIG. 10) along with optional funnels, (FIG. 5) and positioning tools, (FIGS. 7 and 8), and bottle caps, either figural or plain (FIGS. 6 and 13). Such bottle caps might also provided with a source of illumination (FIG. 14). The use of illumination in the bottle to create a lit interior may include a LED or solar light button on the bottle cap (FIG. 12), as is the inclusion of a musical button on the bottle cap. (FIG. 12).

The kit would be presented to children as a boxed set to be assembled. The set would come with a set of instructions as to how to place the painted figure in the bottle. Two or more co-joined bottles might be produced with a pair of figures (such as Bugs Bunny and Porky Pig or the Statue of Liberty and the Empire State Building).

Although “impossible” bottles have been created before (refer to Background of invention), none have been created that are so uncomplicated to assemble and so suitable for children to construct.

1. A method of producing a novelty arts and crafts set comprised of a rubber or vinyl plastic object, a paint set and a small, narrow necked transparent glass or plastic container of round, square, or oval shape; wherein said rubber object can be twisted and rolled into the neck of the transparent container before it blows up to its original size; thereby filling the container with a three dimensional object which is permanently enclosed in the interior of the container.

2. The figure as set forth in claim 1 is twisted and rolled through the narrow neck of the transparent container with a motion similar to that of turning a corkscrew to come to be permanently inserted in said container, thereby making it impossible to remove without breaking the plastic or glass container.

3-9. (canceled)

10. The rubber or vinyl plastic objects as set forth in claim 1 to consist of various types of three dimensional figures or objects, [such as} super heroes, sports figurines, cartoon characters, famous people, transportation items, city profiles, Sci-fi figures, architectural structures, mythological beasts, [human anatomically related objects or organs,] or any other object capable of being twisted and rolled into a glass or plastic container with a small neck opening.

11. (canceled)

12. (canceled)

13. (canceled)

14. (canceled)

15. (canceled)

16. (canceled)

17. (canceled)

18. (canceled)

19. (canceled)
